(19) United States
(12) Patent Application Publication
(10) Pub. No.: US 2018/0247207 A1
(43) Pub. Date: Aug. 30, 2018

(54) ONLINE HIERARCHICAL ENSEMBLE OF LEARNERS FOR ACTIVITY TIME PREDICTION IN OPEN PIT MINING

(71) Applicant: HITACHI, LTD., Tokyo (JP)

(72) Inventors: Kosta RISTOVSKI, San Jose, CA (US); Chetan GUPTA, San Mateo, CA (US)

(73) Assignee: HITACHI, LTD.

(21) Appl. No.: 15/441,939

(22) Filed: Feb. 24, 2017

(51) Int. Cl. G06N 5/04; G06N 99/00; G07C 5/02

(52) U.S. Cl. CPC G06N 5/04; G07C 5/02; G06N 99/005

(57) ABSTRACT

Example implementations described herein are directed to vehicle scheduling and management, and in particular for estimation of travel times and other activity times. Example implementations can be used to achieve improved vehicle scheduling and utilization based on the provision of accurate expected activity times. Example implementations are further directed to the integration of predictors to provide an estimation of activity time.

### BACKGROUND

### Field

The present application is generally directed to vehicle operations and more specifically, to tracking activities of vehicles such as trucks in a mining operation.

### Related Art

In open pit mining, huge quantities of ore and waste material are transported using large equipment. The major components of material handling are trucks, shovels and loaders. Trucks, depending on the size and manufacturer, are often organized into fleets. Depending on the material type, trucks may haul material from either shovels or loaders to the following destinations: dump areas/sites in the case of waste, and stockpiles or processing plants in the case of ore. Besides hauling, other main productive activities are material dumping, trucks driving empty, trucks loading, trucks spotting at shovel, and so on.

Due to the stochastic nature of activity durations and poor scheduling, non-productive activities (NPT) such as truck queuing and shovel starving (e.g., waiting for trucks to be loaded) are present. In order to compete in the market and have sustainable and economical mining operations, companies attempt to improve their efficiency and reduce operational cost by decreasing the time spent in these non-productive activities. Truck assignment as a part of a dispatching system has a role to determine the number of trucks from each fleet that should be operating between any particular pair of loading (loaders, shovels) and dumping locations (dump areas) to meet production requirements. Material transportation can represent up to 40% of operating costs and hence reducing NPT in these systems can lead to savings for a mine operation.

Depending on the material type, trucks usually haul from either shovels or loaders to the following destinations: dump area in the case of waste, and stockpile or processing plant in the case of ore. Besides hauling, other main productive activities are material dumping, trucks driving empty, trucks loading, trucks spotting at shovel. Accurate predictions of activity times for these activities will result in better operational planning (truck assignment) as well as in better decision in dynamic dispatch of the trucks.

### SUMMARY

Example implementations described herein are directed to system that provides more accurate predictions, which may lead to reduction in NPT and lower the cost of production.

Aspects of the present disclosure can include a method for managing a plurality of vehicles. The method can involve managing information associated with an activity from the plurality of vehicles, and a plurality of predictive models, wherein each of the plurality predictive models is constructed based on one or more subsets of the information; for an activity associated with a first vehicle from the plurality of vehicles, determining which of the plurality of predictive models are relevant to the activity of the first vehicle, assigning a weight to each of the plurality of predictive models based on the activity, relevancy, one or more parameters of the first vehicle and the information stored in the memory; aggregating the weighted predictive models; and generating an estimation for activity time of the activity for the first vehicle based on the aggregation.

Aspects of the present disclosure further include a non-transitory computer readable medium, storing instructions for executing a process for managing a plurality of vehicles. The instructions can include managing information associated with an activity from the plurality of vehicles, and a plurality of predictive models, wherein each of the plurality predictive models is constructed based on one or more subsets of the information; for an activity associated with a first vehicle from the plurality of vehicles, determining which of the plurality of predictive models are relevant to the activity of the first vehicle, assigning a weight to each of the plurality of predictive models based on the activity, relevancy, one or more parameters of the first vehicle and the information stored in the memory; aggregating the weighted predictive models; and generating an estimation for activity time of the activity for the first vehicle based on the aggregation.

Aspects of the present disclosure include an apparatus, configured to manage a plurality of vehicles. The apparatus can include a memory, configured to store information associated with an activity from the plurality of vehicles, and a plurality of predictive models, wherein each of the plurality predictive models is constructed based on one or more subsets of the information; and a processor, configured to, for an activity associated with a first vehicle from the plurality of vehicles, determine which of the plurality of predictive models are relevant to the activity of the first vehicle, assign a weight to each of the plurality of predictive models based on the activity, relevancy, one or more parameters of the first vehicle and the information stored in the memory; aggregate the weighted predictive models; and generate an estimation for activity time of the activity for the first vehicle based on the aggregation.

Aspects of the present disclosure include a system, configured to manage a plurality of vehicles. The system can include means for storing information associated with an activity from the plurality of vehicles, and a plurality of predictive models, wherein each of the plurality predictive models is constructed based on one or more subsets of the information; and, for an activity associated with a first vehicle from the plurality of vehicles, means for determining which of the plurality of predictive models are relevant to the activity of the first vehicle, means for assigning a weight to each of the plurality of predictive models based on the activity, relevancy, one or more parameters of the first vehicle and the information stored in the memory; means for aggregating the weighted predictive models; and means for generating an estimation for activity time of the activity for the first vehicle based on the aggregation.

### BRIEF DESCRIPTION OF DRAWINGS

FIG. 1 illustrates an example operation of trucks and shovels, in accordance with an example implementation.

FIGS. 2(a) to 2(d) illustrate example graphical structures and subsets for vehicle activities, in accordance with an example implementation.

FIG. 3 illustrates a logical view of a vehicle scheduling system, in accordance with an example implementation.

FIG. 4 illustrates an example flow for a mechanism configured to achieve prediction and integration, in accordance with an example implementation.

FIG. 5 illustrates a hardware diagram for a computer system, in accordance with an example implementation.

FIG. 6 illustrates an example of vehicle information in accordance with an example implementation.

FIG. 7 illustrates an example of topology information, in accordance with an example implementation.

FIG. 8 illustrates an example of vehicle activity information, in accordance with an example implementation.

FIGS. 9(a) to 9(c) illustrate example flow diagrams for estimating activity time, in accordance with an example implementation.

FIG. 10 illustrates an example flow diagram for updating the system based on receipt of results of the activity from the vehicles, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Truck assignment and truck distribution may be used interchangeably. Example implementations described herein may be used singularly, or in combination other example implementations described herein, or with any other desired implementation.

Example implementations described herein are directed to providing prediction of activity times of vehicles, which can be obtained through the following implementations. For each activity, relevant graph structures are defined for learning different predictive models. The structure defines multiple subsets over the data and learns different models for each of the subsets. Further, outliers are removed from operational data related to activity times. Example implementations utilize a combination of single and multi-dimensional outlier detection techniques to remove the outliers. Then, example implementations learn different machine learning models based on the defined structure. The predictions of the predictive models are integrated in real time through the use of time varying weights, which takes into account that some models may not provide predictions all the time.

Example implementations involve obtaining a solution for the prediction of activity times as an integration of multiple different predictors based on a pre-defined graphical structure. In example implementations, the difference in predictors comes from either machine learning model structure or the data selected to learn machine learning model. Predictors can be integrated using online weighted average where weights are updated after each new observation.

Example implementations may utilize machine learning models and historical data to predict the duration of activities and parameters of activity duration distribution. Parameters of the distributions of activity durations for use in the prediction of activity times, can be obtained as output of a machine learning model which takes into account several variables such as terrain, weather, type of truck, and so on, depending on the desired implementation.

Through the use of the example implementations described herein, accurate activity time predictions can be obtained to improve dispatching and reduce cost of mine operations.

Although example implementations described herein are described with respect to trucks in a mining operation, the present disclosure is not limited thereto and the example implementations can be extended to any vehicle that conducts any activities that are subject to scheduling. Such vehicles can include shovels, railcars, automobiles, boats, airplanes, and so on, depending on the desired implementation. Such activities can include delivery offloading, material or personnel loading, hauling, refueling, maintenance, and so on, depending on the desired implementation.

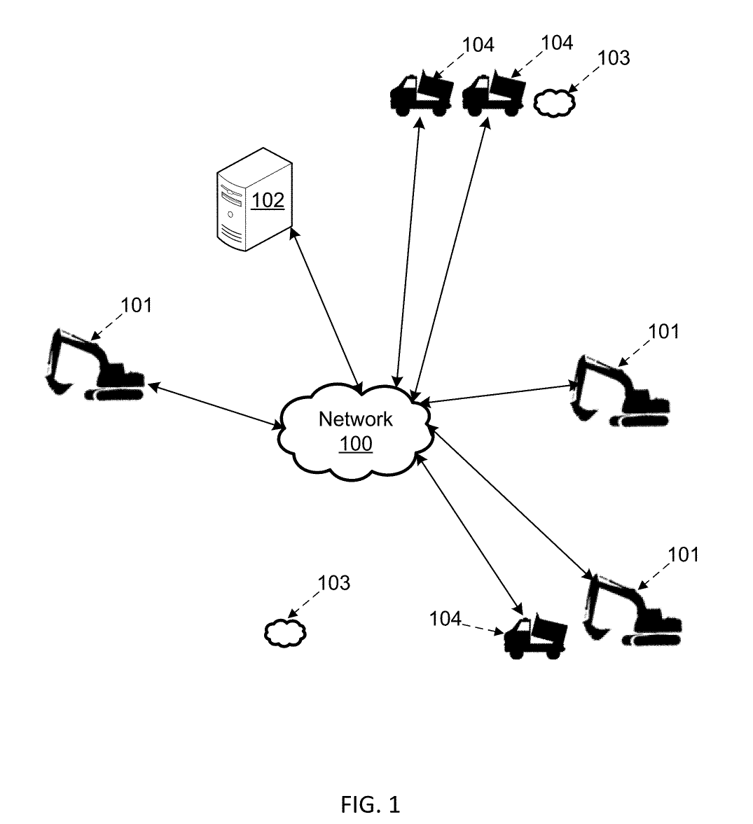

FIG. 1 illustrates an example operation of vehicles such as trucks and shovels, in accordance with an example implementation. The mining operation may include a plurality of shovels 101, a plurality of trucks 104, dump sites 103, and other vehicles depending on the desired implementation. Trucks 104 and/or shovels 101 may be communicatively coupled to a computer system 102 through a network 100. Trucks 104 may navigate to shovels 101 to receive a payload and may also form a queue in front of shovels 101 when the shovels are being utilized. Trucks may also navigate to dump sites 103 to offload the payload.

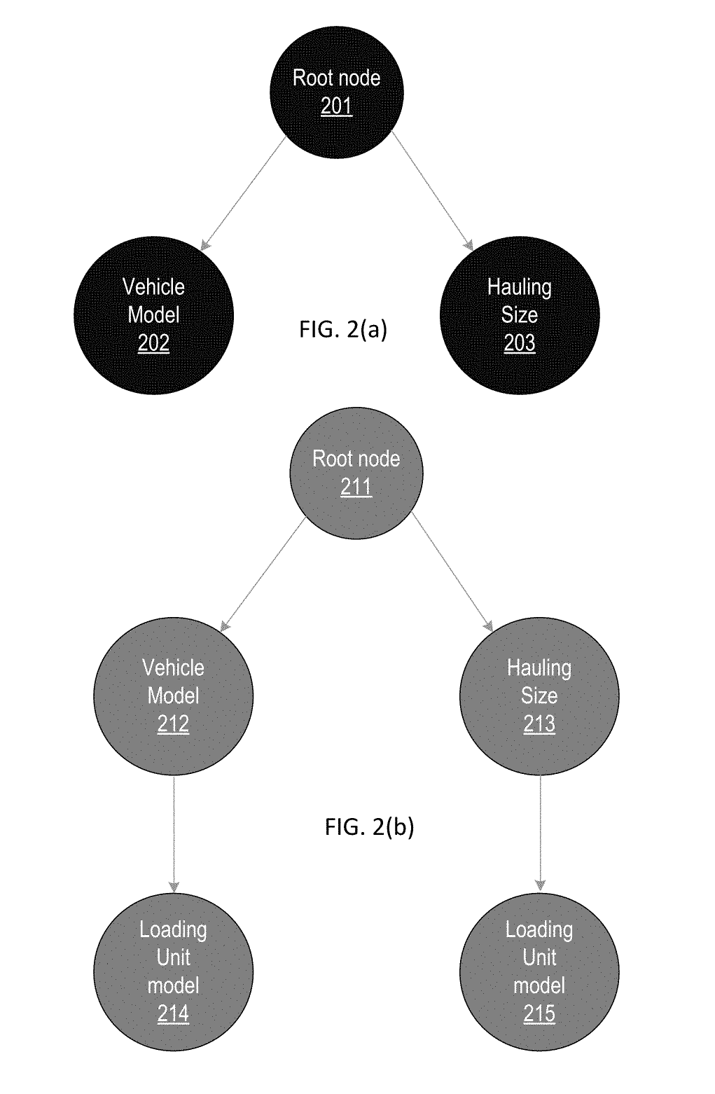

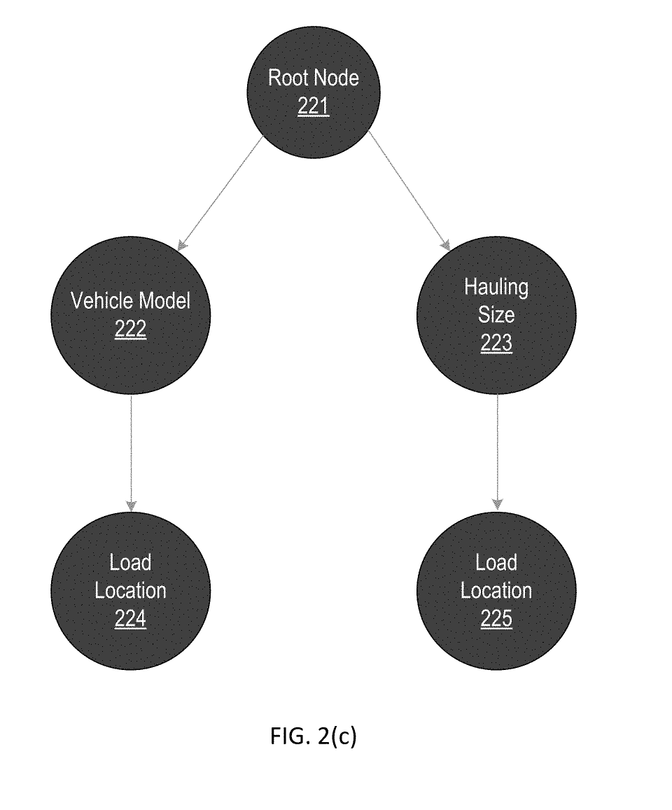

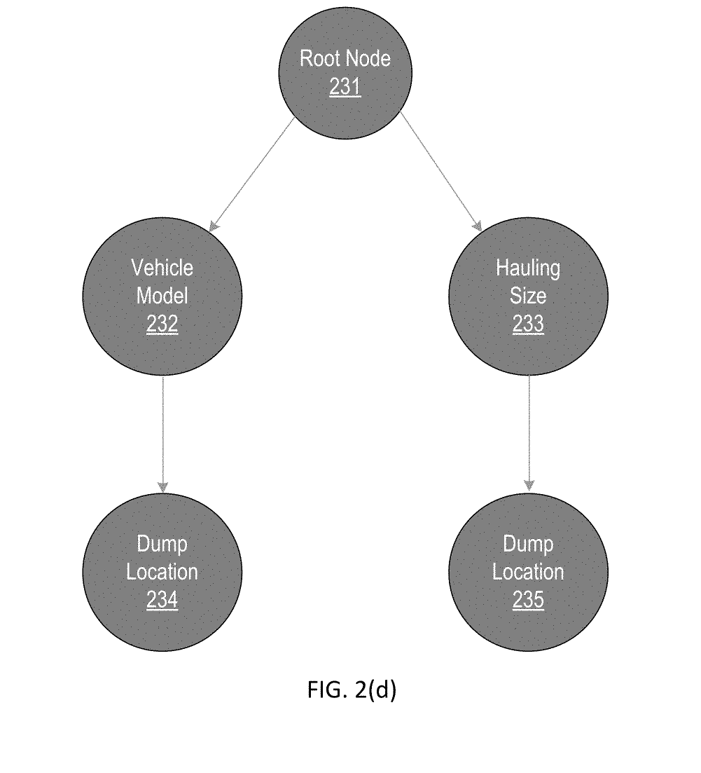

As illustrated in FIGS. 2(a) to 2(d), data can be partitioned into one or more subsets to determine parameters that can facilitate more accurate predictions for each given activity. In example implementations, various graphical hierarchies for each activity can be utilized to introduce data filtering over the variables on paths as follows.

FIG. 2(a) illustrates a graphical structure for the hauling and empty activity, in accordance with an example implementation. Although the structures for each of the model may be similar, different types of predictive models can be utilized for each activity. According to the structure at the root node 201, a predictive model can be trained by using the complete dataset. At the child nodes, example implementations differentiate vehicle model 202 and hauling size 203. In the case of vehicle model 203, subsets of the data can be created corresponding to vehicle models, which are defined by, for example, vendor name and model number, and predictive models can be trained on each subset. In the case of hauling size, vehicles such as trucks can be differentiated based on hauling capacity (e.g. 20 tons, 50 tons, etc.) regardless of vehicle models and manufacturers. Thus, the aggregated predictor model for a given set of vehicle data can involve the predictor for the vehicle model type, the predictor for the particular hauling capacity, and the predictive model trained by using the complete data set.

FIG. 2(b) illustrates a graphical structure (tree) for loading activity, in accordance with an example implementation. According to the structure at the root node 211, a predictive model is trained using the complete dataset. At the first depth level, example implementations differentiate vehicle model and hauling size. Example implementations create subsets of data based on vehicle model and hauling size as in the structure of FIG. 2(a) and learn the models to predict activity duration. At the second depth level, example implementations are extended to created more subsets. At this level, example implementations consider subsets based on all variables on a path from the root node 211 which include first creation of subsets of vehicle model 212 and loading unit model 214, and a second creation of subsets of hauling size 213 and loading unit model 215. Example implementations thereby learn new predictive models on these subsets.

FIG. 2(c) illustrates a graphical structure (tree) for spotting activity, in accordance with an example implementation. The example structure of FIG. 2(c) is similar to the one for loading activity in FIG. 2(b) with a similar structure for root node 221, vehicle model 222, and hauling size 223, however, the finest subset creation is different. As the loading location can be differentiator for spotting activity, the loading location 224 and 225 is introduced at the second depth level of the tree. Example implementations learn predictive models on all subsets.

FIG. 2(d) illustrates a graphical structure (tree) for dumping activity, in accordance with an example implementation. The structure of FIG. 2(d) is similar to the one for spotting activity for FIG. 2(c) for the root node 231, the vehicle model 232 and the hauling size 233, however, the leaf nodes are changed in the example of FIG. 2(d). As dump location 234 and 235 can be a differentiator for dumping activity, example implementations utilize dump location at the second depth level of the tree, and learn predictive models on all subsets.

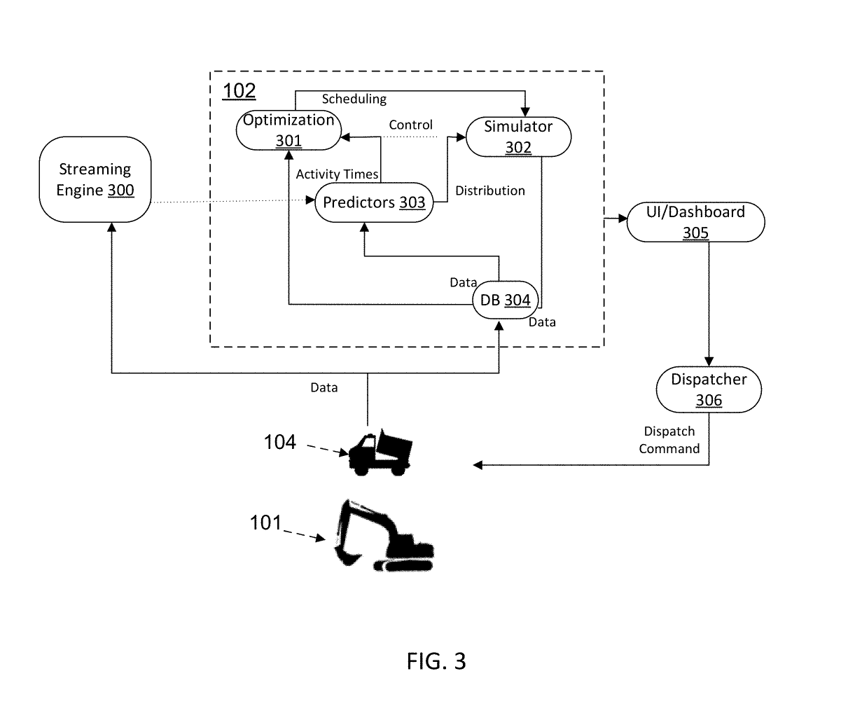

FIG. 3 illustrates a logical view of a vehicle scheduling system, in accordance with an example implementation. Sensor data coming from the vehicles 101, 104 can be processed through a streaming engine 300 in real time, and processed in batches or windows by computer system 102. Data is processed by the computer system 102 and stored in a relational database 304. Predictive models 303 may predict: (i) activity durations and (ii) activity scheduling for vehicles based on the using historical data obtained from the database and data obtained from the streaming engine 300.

The outputs of the machine learning models as well as data from the database are used as input parameters for optimization modules 301. The outputs of both simulation 302 and predictors 303 along with the data from database 304 can be used in the stochastic optimization that may generate additional predictors or weights for the forecasting of activity times and optimized scheduling. The obtained vehicle activity time forecasts and optimized scheduling can be displayed on a dashboard 305 so that a dispatcher 306 can determine the forecasted activity times and scheduling for the vehicles managed by the vehicle scheduling system. As illustrated in the system of FIG. 3, example implementations can therefore provide a prediction based on any batch of data received from any vehicle at any given point in time.

In example implementations for model learning and outlier removal for machine learning 303, multiple models can be created for each of graphical structures and each activity. Examples of such models are moving average, exponential smoothing, linear and nonlinear regression, and so on. Denote each of these models as Mᵢₐ(X_{ia,s}), iₐ=1,2, . . . ; a ∈ A={loading, hauling, dumping, empty, spotting, . . . } where X_{ia,s} is set of explanatory variables for a particular model and activity on particular subset s. The set of these variables should be kept the same at each node in the tree given the model. For example, if linear regression is utilized for predicting the hauling activity duration, relevant set of explanatory variables for the model might include distance, route elevation difference, weather, shift, and so on. Also, the same set of explanatory variables, if it provides the best fit, should be used in each of the nodes. From a prediction perspective, the explanatory variables can be chosen such that they are obtainable in the near future and can be consumed by the model. For example, shift can be an important explanatory variable for activity durations because conditions may differ during the night versus the day. Weather data can also be important, since in case of rain or high winds, vehicles may move slower than usual. For each of the models and each data subset based on the graphical structure, outliers can be detected and removed assuming that there is enough data to learn the models after outlier removal. Examples of predictive models in Fleet Management Systems can include moving average and exponential smoothing. Example implementations facilitate the application of any of these models through the following of the graphical structure.

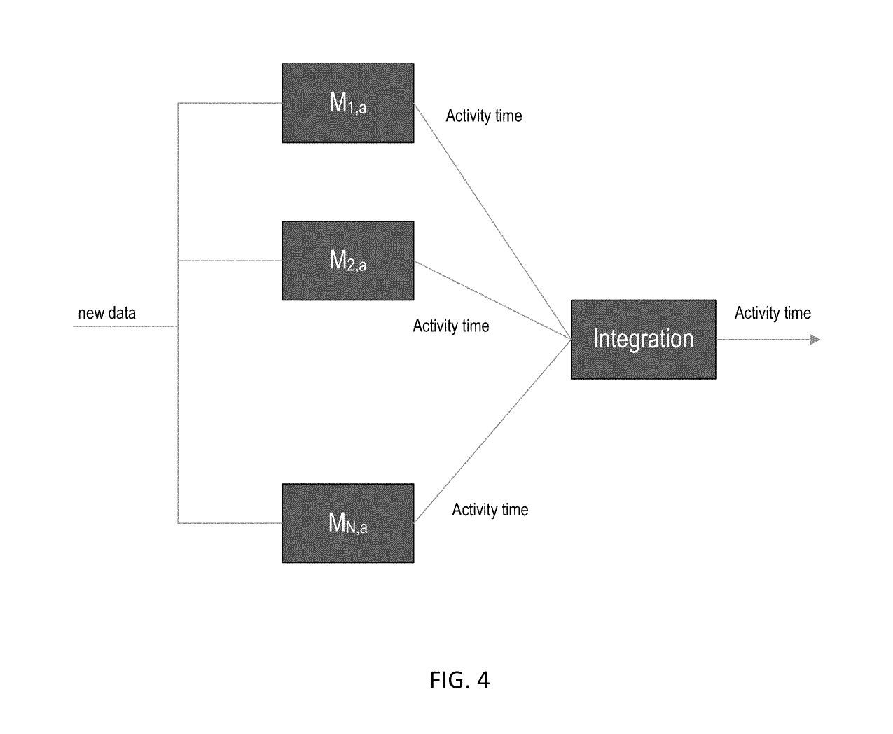

FIG. 4 illustrates an example flow for a mechanism configured to achieve prediction and integration, in accordance with an example implementation. Example implementations may facilitate online predictions and integration. In example implementations, one or more predictive models can be created for each of the activities through following a hierarchical structure. Assuming that there are N predictive models learned on all subsets for particular activity a ∈ A, then for new data points which are arriving in an online fashion, example implementations can apply the models. Sometimes models may not be applicable to the new data points and therefore may not provide prediction. Example implementations address this scenario by, for example, creating subsets of the data based on the vehicle model and learning the models for hauling on the each of the subsets. If new models of vehicles are utilized, although models for hauling learned on the subset based on the vehicle models may not be able to provide predictions, models at the root node can provide predictions as they are more general.

In example implementations, there are multiple predictors over multiple subsets. Each of predictors provides its own estimate of the activity time, but in some cases prediction may not be possible for some of the predictors (e.g. predictor directed to a first type of vehicle model may not be predictive for a different vehicle model). Thus, example implementations merge predictions into a single value in online fashion.

Denote w_{ia,s} weight for each of the predictors and subset (denoted as s) and y_{ia,s} predictions of each model and subset. The final prediction can be defined as weighted average of all predictions:

yₐ=Σ_{ia,s}w_{ia,s}y_{ia,s} where Σ_{ia,s}w_{ia,s}=1

Example implementations define w_{ia,s}. That is, example implementations are directed to assigning a weight to each of the predictors and subsets based on historical performance. Historical performance is measured by the loss function value for each predictor and subset over last k observations. Using the loss, weights can be defined as:

$${w}_{i , p} = \frac{{I}_{ia , s} exp ( - \frac{1}{c} l ( {y}_{true} , {y}_{ia , s} ) )}{{\sum }_{ia} {\sum }_{s} {I}_{ia , s} exp ( - \frac{1}{c} l ( {y}_{true} , {y}_{ia , s} ) )}$$

where I_{ia,s} is binary indicator if predictor is provides prediction at subset s. Constant c is utilized to scale the loss function and can be determined as the standard deviation of the historical activity times over the last K observations. Loss function denoted as l can be defined as quadratic loss:

$$l ( {y}_{true} , {y}_{ia , s} ) = \frac{1}{{\sum }_{k} {I}_{ia , s , k} {α}_{k}} {\sum }_{k} {I}_{ia , s , k} {{α}_{k} ( {y}_{true , k} - {y}_{ia , s , k} )}^{2}$$

however, any other loss function can be utilized depending on the desired implementation. I_{ia,s,k} is binary indicator if predictor iₐ provided prediction at subset s, at k-th closest observation in the past. Also, different weights can be utilized for different historical observations (e.g. closer observation are weighted as higher importance) using the term αₖ defined as

αₖ=exp(−α*k)

where α is discounting factor which is application specific.

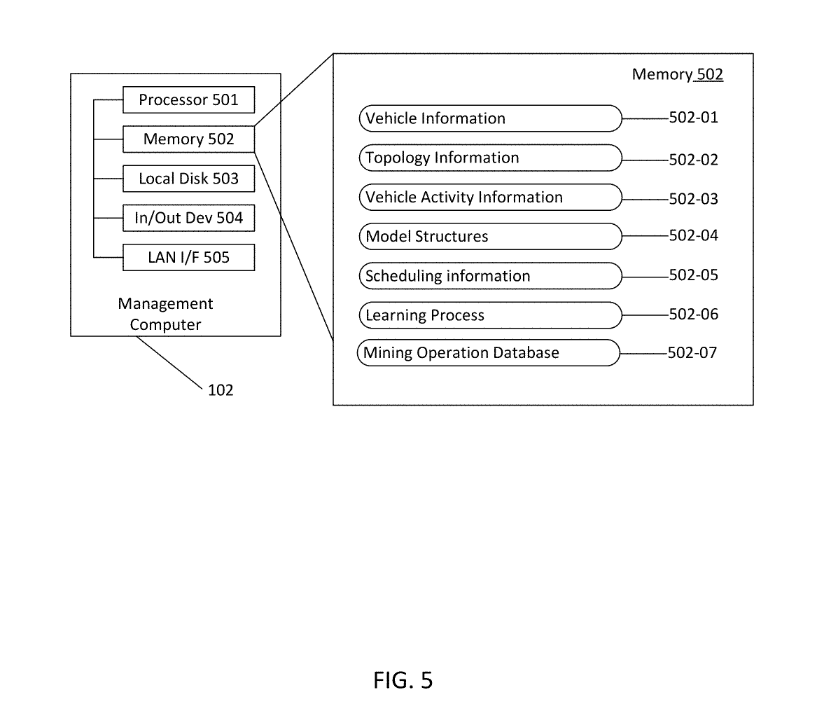

FIG. 5 illustrates a hardware diagram for a computer system, in accordance with an example implementation. Computer system 102 may be implemented as a management computer which is configured with a processor 501, memory 502, local disk 503, input/output (I/O) device 504 and local area network interface (LAN I/F) 505. Memory 502 may be implemented the form of a storage such as a storage system, a computer readable medium, random access memory (RAM) and so forth depending on the desired implementation. Memory 502 may be configured to store vehicle information 502-01, topology information 502-02, vehicle activity information 502-03, model structures 502-04, scheduling information 502-05, a learning process 502-06, and a mining operation database 502-07. Processor 501 may be configured to refer to memory 502 and invoke the learning process 502-06 as needed to implement the flow diagrams as described herein.

In example implementations, the machine learning model for activity durations are built to utilize as much relevant data as needed. Depending on activity, explanatory variables can be obtained from truck activity, topology, and truck details based on information stored in the memory of the computer system. Such variables can include shift information, weather data, route characteristics, vehicle health data such as original equipment manufacturer (OEM) data and so on. For the machine learning model to learn to predict each activity duration, the durations are provided in vehicle activity information 502-03.

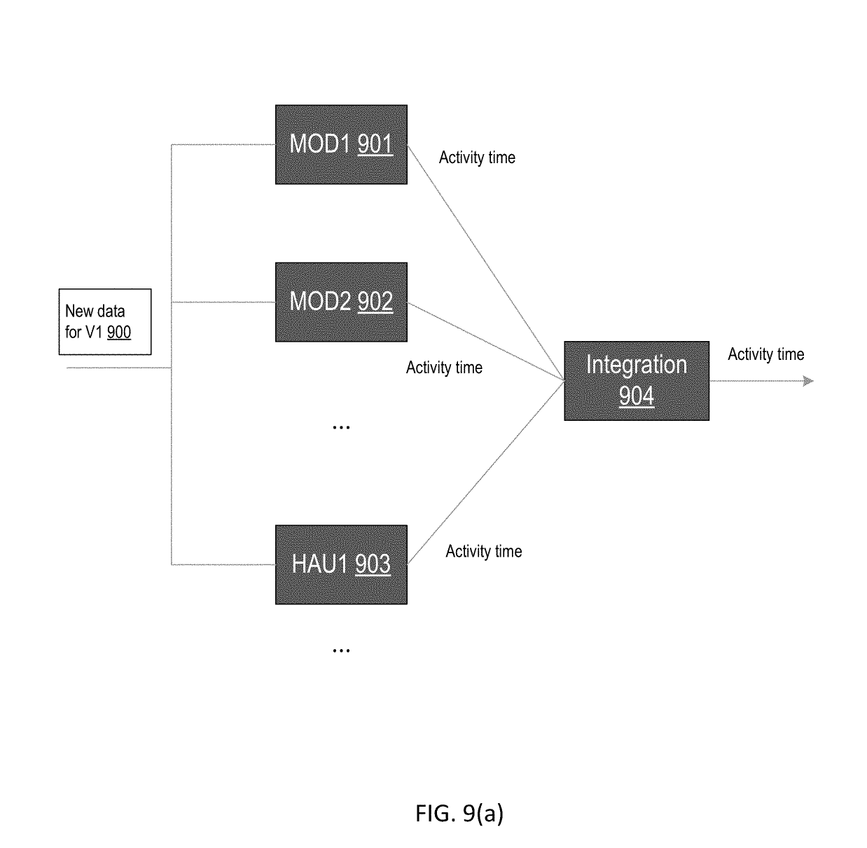

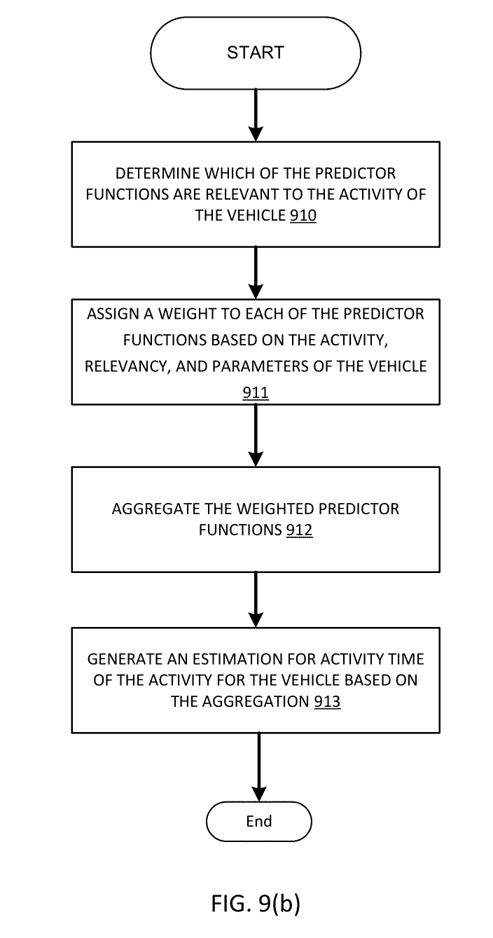

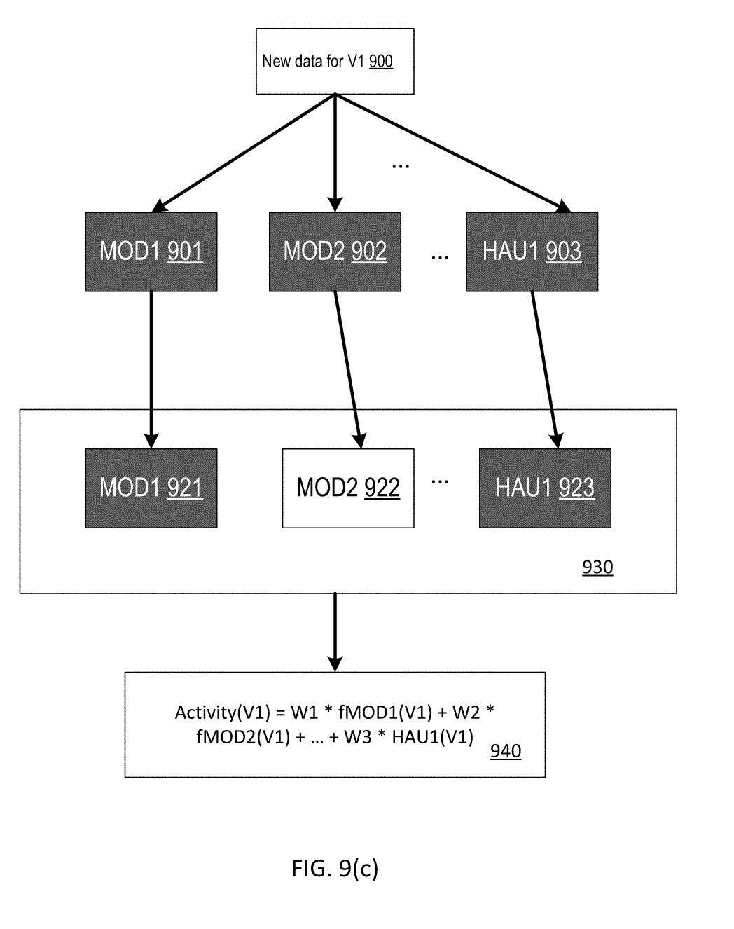

Model structures 502-04 can store the structures that relate subsets to the corresponding activity as illustrated in FIGS. 2(a) to 2(d), as well as the corresponding predictive models as illustrated, for example, in FIGS. 9(a) to 9(c) along with the corresponding hierarchies. Model structures 502-04 can also manage the integration function as illustrated in FIG. 4. Learning process 502-06 can contain one or more machine learning or statistical algorithms (e.g. linear regression, artificial neural networks, deep learning, running average, etc.) that can be executed to generate the predictive models, as well as to calculate and provide weights to model structures 502-04 to carry out the activity time calculation as illustrated in FIGS. 9(a) to 9(c). Each machine learning algorithm can thereby be configured to provide an estimate of activity time for an activity from a vehicle based on a function of corresponding subsets from the one or more subsets of the information as illustrated in FIGS. 2(a) to 2(d) and FIGS. 9(a) to 9(c) and can be constructed from machine learning. Scheduling information 502-05 can include the schedules for all of the vehicles managed by the management computer 102. Mining operation database 502-07 can involve a database of all information streamed to management computer 102 pertaining to the mining operations conducted.

In example implementations described herein, management computer 102 can be configured to manage a plurality of vehicles, such as a truck fleet or mining trucks in a mining operation. The memory 502 can be configured to store information associated with an activity from the plurality of vehicles such as vehicle information 502-01, topology information 502-02, and vehicle activity information 502-03, along with a plurality of predictive models managed by model structures 502-04. Each of the plurality of predictive models can be constructed based on one or more subsets of the information as illustrated in FIGS. 2(a) to 2(d). Such subsets can include vehicle model, hauling size, loading unit (e.g. shovel loading, rail loading, etc.), loading location (e.g. topology around location, weather, etc.), and so on, depending on the desired implementation. Other subsets can be constructed based on domain knowledge or through other methods depending on the desired implementation. Such activities can include the hauling and empty operation, the loading operation, and the dumping operation as illustrated in FIGS. 2(a) to 2(d), but is not limited thereto. Other activities may also be incorporated in accordance with the desired implementation.

Processor 501 can be in the form of hardware processors that are configured to a processor, configured to, for an activity associated with a first vehicle from the plurality of vehicles, determine which of the plurality of predictive models are relevant to the activity of the first vehicle, assign a weight to each of the plurality of predictive models based on the activity, relevancy, and one or more parameters of the first vehicle and the information stored in the memory 502, aggregate the weighted predictive models; and generate an estimation for activity time of the activity for the first vehicle based on the aggregation as illustrated in FIGS. 9(a) to 9(c).

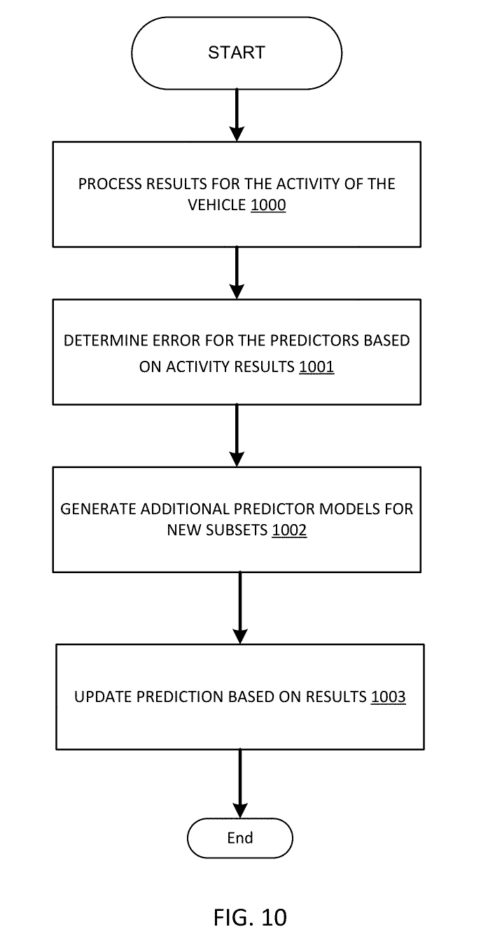

Processor 501 can also be configured to assign the weight to each of the plurality of predictive models based on the recency of use for the predictive model and error margin, as described in FIGS. 9(a) to 9(c) and FIG. 10 and with respect to the formulas as described with respect to FIG. 4.

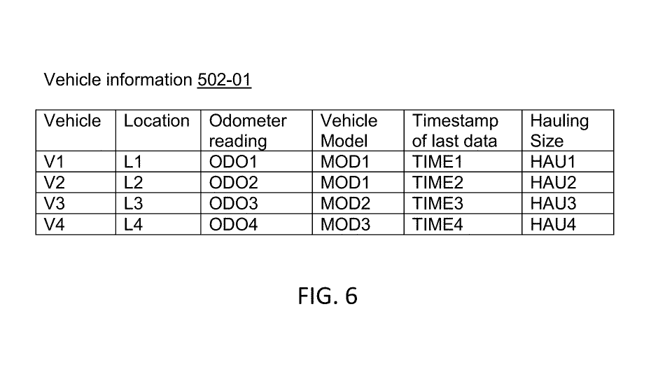

FIG. 6 illustrates an example of vehicle information 502-01 in accordance with an example implementation. Vehicle information may include the vehicle identifier, the last known location of the truck, the time stamp of the latest data received, and OEM information. Such OEM information can include the odometer reading, the vehicle model, hauling capacity, and so on according to the desired implementation. Depending on the desired implementation, the vehicle information 502-01 may include other variables or omit any one of the listed variables.

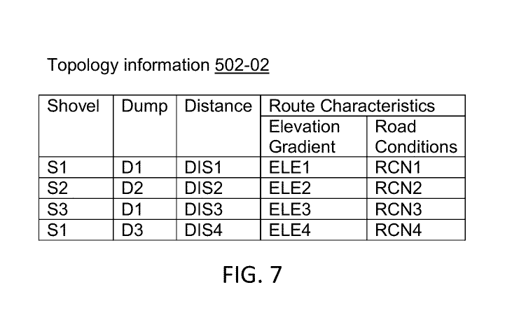

FIG. 7 illustrates an example of topology information 502-2, in accordance with an example implementation. In an example implementation of a mining operation, topology information 502-02 may include shovel identifier, dump site identifier, distance between shovel and dump and route characteristics. Such route characteristics can include the elevation gradient for the route between the shovel and the corresponding dump site and route conditions (e.g., paved, mud, gravel, etc.). Depending on the desired implementation, the topology information 502-02 may include other variables or omit any one of the listed variables according to the desired implementation. For example, in operations involving railcars, topology information can include distance between stations, rail conditions, and so on.

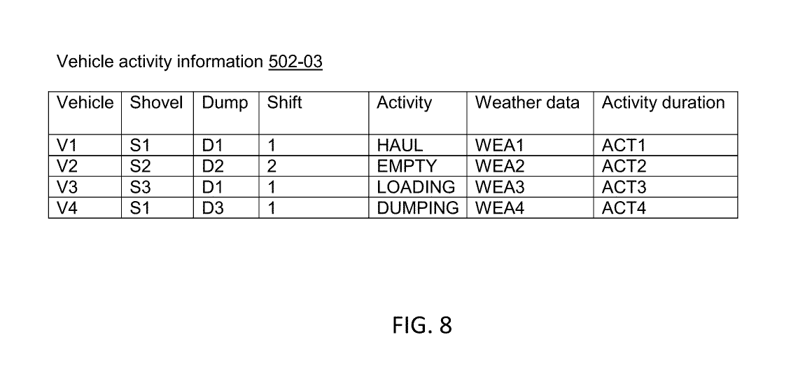

FIG. 8 illustrates an example of vehicle activity information 502-03, in accordance with an example implementation. Vehicle activity information 502-03 can include the vehicle identifier/number, the shovel identifier/number, the dump site identifier/number, shift information, activity information, weather data (e.g., temperature, snow conditions, heavy wind, rain conditions etc.), and activity durations. Depending on the desired implementation, the vehicle activity information 502-03 may include other variables or omit any one of the listed variables.

FIG. 9(a) illustrates an example flow in accordance with an example implementation. Specifically, FIG. 9(a) is an example of an applied implementation of FIG. 4. In example implementations, some predictors may or may not be relevant to the batch of data received by the streaming engine 300. Other predictors may always be relevant for the data (e.g. predictive model based on vehicle loading capacity). Thus, weighting can be applied according to the relevancy of the batch of data received.

In an example implementation, data is transmitted from a vehicle V1 to streaming engine 300 at a given point in time. The data is fed into the predictor models of machine learning 303, which can include a predictor for a first vehicle model MOD1 901, a predictor for a second vehicle model MOD2 902, a predictor for a first type of hauling size HAU1 903, and so on. Predictor models can be constructed for vehicle model, hauling size, and other parameters, depending on the desired implementation.

FIGS. 9(b) and 9(c) illustrate an example flow diagram in accordance with an example implementation. At 910, the flow, upon receiving new data from a vehicle, determines which of the predictive models are relevant to the activity of the vehicle. This can be conducted by selecting the graphical structure that corresponds with the identified activity as illustrated in FIGS. 2(a) to 2(d), and determining which subsets apply to the data to select the predictors. As shown in FIG. 9(c) at 930, predictors determined to be relevant to determining activity time of the vehicle include vehicle model subset with the particular predictor for vehicle model MOD1 921, and load hauling subset with the particular predictor for hauling size HAU1 for determining the activity time of vehicle V1. For example, vehicle V1 may be of vehicle model type MOD1 (shaded), wherein the vehicle model type MOD2 922 (unshaded) may be determined not to be relevant within the vehicle model subset. If vehicle V1 is the vehicle model type of MOD2, then MOD2 may be determined to be relevant and MOD1 may be considered to not be relevant. Hauling size HAU1 923 may be considered to be relevant for vehicle V1, and for data received for any other vehicle having a similar hauling size of vehicle V1.

At 911, the flow assigns a weight to each of the predictive models based on the activity, relevancy, and parameters of the vehicle. Depending on the desired implementation, predictive models determined not to be relevant can be assigned a weight of zero. For example, a vehicle being a model type of MOD1 may have a weight of zero for the models directed to the vehicle model type MOD2, MOD3 and so on. For normalization purposes, the sum of all of the weights can be 1 to determine the influence of each of the predictors. In an example implementation, relevancy can be determined based on a threshold, whereupon a relevancy score falling below the threshold will be considered not to be relevant. In another example implementation, relevancy can be normalized to be used as weights in the flow at 912. The determination of relevancy can be implemented in any manner according to the desired implementation, and is not particularly limited to any implementation.

Weights may also be modified based on the recency of the data used for the predictive model. For example, the predictive models utilized for the integration 904 may not all be utilizing the most recent data from the vehicle V1 900, due to the data not being sent from V1 or for other reasons. In such cases, the relevant predictive models that incorporate data may not utilize the most recent data when they are incorporated for the integration 904. For example, at a window of time T, vehicle V1 900 may transmit data indicating the present location of the vehicle without any information regarding current weather conditions. The predictive models related to the vehicle model and the location of the vehicle can utilize the most recent data, however, the predictive model for the weather conditions may not have the most recent data (e.g. last available data is T-x time frames ago). Thus when aggregation is conducted, the predictive models utilizing more recent data can be weighted higher than the predictive models utilizing less recent data. The adjustment of the weighting due to recency can be conducted in accordance with the desired implementation, and is not particularly limited. Further, weights may be adjusted based on the expected error for the predictive model. The error can be determined after results of the activity are received, as illustrated in the flow of FIG. 10. Predictive models having less error can be weighted more heavily than predictive models having a larger error. The adjustment of the weighting due to the error can be conducted in accordance with the desired implementation, and is not particularly limited.

At 912, the flow aggregates the weighted predictive models based on the assigned weights. As shown at 940 from FIG. 9(c), the predictive models are each assigned a weight W1, W2, W3, and so on, and the activity time can be determined from a sum of all of the weighted predictive models at 913. The flow of FIGS. 9(a) to 9(c) can be executed for each batch of data received from a vehicle at a given point in time as illustrated in FIG. 6.

FIG. 10 illustrates an example flow diagram for updating the system based on receipt of results of the activity from the vehicles, in accordance with an example implementation. In example implementations, the weights for the predictors along with new predictive models can be generated based on results of the activities of the vehicle received in real time. At 1000, results for the activity of the vehicle are processed. The results can be in the form of a communication from the vehicle indicating that the activity is complete, or that the vehicle has switched to another activity, or so on, depending on the desired implementation. At 1001, the error between the predicted activity time and the actual activity time is determined. The error is stored and then utilized in future applications of the predictor through being utilized as a factor for the weights. For example, predictive models having a larger error can be weighted less than predictive models having a smaller error. Error can be utilized in the weight determination in any manner according to the desired implementation. An example of a function for error is the loss function as described above.

At 1002, the flow generates additional predictive models for new subsets, if necessary. Such situations can occur if a new vehicle is introduced to the system that has parameters that are different from the rest of the fleet (e.g. new vehicle model, new hauling capacity, etc.) and is not in the database of the other vehicles of the system. In such cases, relevant predictors are selected for making the predictions through the use of the flow as illustrated in FIGS. 9(a) to 9(c). When sufficient amounts of data are collected for the new parameters to generate a predictor through machine learning, such predictors can thereby be generated and incorporated for future use.

At 1003, the prediction can be updated based on the new results through the execution of the flows as illustrated in FIGS. 9(a) to 9(c). The updated predictions can thereby be utilized to update or change the activity schedule. In an example implementation, the updated predictions can be utilized to automatically generate a schedule for the managed vehicles, which is communicated to the vehicles through dispatcher 306 of FIG. 3.

In an example implementation of a control system involving the updated predictions from the flow of FIG. 10, processor 501 of management computer 102 can be configured to process the updated predictions to generate a schedule of activities for the managed vehicles, which is dispatched to the vehicles through dispatcher 306. The schedule of activities can be automatically generated based on the updated predictions, or can be manually submitted through an interface upon alerting the administrator of an updated prediction. The schedule of activities can, for example, be preset by an administrator and include a scheduled time for each of the activities, which is dispatched to each vehicle through dispatcher 306. The scheduled time for each of the activities, or the order of the activities can then be updated automatically by the updated predictions according to the current activities of each vehicle. In this manner, the vehicle schedules can be updated automatically, thereby reducing NPT within an operation involving the managed vehicles.

In another example implementation of a control system involving the updated predictions from the flow of FIG. 10, the updated predictions can be utilized by processor 501 of management computer 102 to schedule maintenance or replacement of vehicles based on estimated completion times. For example, if a new vehicle is to be dispatched into the fleet to replace a vehicle, the new vehicle can be automatically assigned an activity through dispatcher 306 based on the predicted completion time of the vehicle to be replaced, wherein processor 501 of management computer 102 automatically schedules the replaced vehicle to undergo maintenance through dispatcher 306. Through this example implementation, the vehicles managed by management computer 102 can be seamlessly replaced by new vehicles as needed, and maintenance can be applied to the fleet while minimizing the NPT within the operation involving the managed vehicles.

Finally, some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. An apparatus, configured to manage a plurality of vehicles, the apparatus comprising:
a memory, configured to store information associated with an activity from the plurality of vehicles, and a plurality of predictive models, wherein each of the plurality predictive models is constructed based on one or more subsets of the information;
a processor, configured to, for an activity associated with a first vehicle from the plurality of vehicles:
determine which of the plurality of predictive models are relevant to the activity of the first vehicle,
assign a weight to each of the plurality of predictive models based on the activity, relevancy, one or more parameters of the first vehicle and the information stored in the memory;
aggregate the weighted predictive models; and
generate an estimation for activity time of the activity for the first vehicle based on the aggregation.

2. The apparatus of claim 1, wherein the one or more subsets of the information comprises hauling size and vehicle model.

3. The apparatus of claim 1, wherein the processor is configured to assign the weight to each of the plurality of predictive models based on: recency of use of the each of the plurality of predictive models and error margin of the each of the plurality of predictive models.

4. The apparatus of claim 1, wherein the plurality of vehicles are mining trucks.

5. The apparatus of claim 1, wherein each of the plurality of predictive models are configured to provide an estimate of activity time for the activity based on a function of corresponding subsets from the one or more subsets of the information and are constructed from machine learning.

6. The apparatus of claim 1, wherein the activity from the plurality of vehicles is at least one of: hauling and empty operation, loading operation, and dumping operation.

7. A method for managing a plurality of vehicles, the method comprising:
managing information associated with an activity from the plurality of vehicles, and a plurality of predictive models, wherein each of the plurality predictive models is constructed based on one or more subsets of the information;
for an activity associated with a first vehicle from the plurality of vehicles:
determining which of the plurality of predictive models are relevant to the activity of the first vehicle,
assigning a weight to each of the plurality of predictive models based on the activity, relevancy, one or more parameters of the first vehicle and the information stored in the memory;
aggregating the weighted predictive models; and
generating an estimation for activity time of the activity for the first vehicle based on the aggregation.

8. The method of claim 7, wherein the one or more subsets of the information comprises hauling size and vehicle model.

9. The method of claim 7, wherein the assigning the weight to each of the plurality of predictive models is based on: recency of use of the each of the plurality of predictive models and error margin of the each of the plurality of predictive models.

10. The method of claim 7, wherein the plurality of vehicles are mining trucks.

11. The method of claim 7, wherein each of the predictive models are configured to provide an estimate of activity time for the activity based on a function of corresponding subsets from the one or more subsets of the information and are constructed from machine learning.

12. The method of claim 7, wherein the activity from the plurality of vehicles is at least one of: hauling and empty operation, loading operation, and dumping operation.

13. A non-transitory computer readable medium, storing instructions for executing a process for managing a plurality of vehicles, the instructions comprising:
managing information associated with an activity from the plurality of vehicles, and a plurality of predictive models, wherein each of the plurality predictive models is constructed based on one or more subsets of the information;
for an activity associated with a first vehicle from the plurality of vehicles:
determining which of the plurality of predictive models are relevant to the activity of the first vehicle,
assigning a weight to each of the plurality of predictive models based on the activity, relevancy, one or more parameters of the first vehicle and the information stored in the memory;
aggregating the weighted predictive models; and
generating an estimation for activity time of the activity for the first vehicle based on the aggregation.

14. The non-transitory computer readable medium of claim 13, wherein the one or more subsets of the information comprises hauling size and vehicle model.

15. The non-transitory computer readable medium of claim 13, wherein the assigning the weight to each of the plurality of predictive models is based on: recency of use of the each of the plurality of predictive models and error margin of the each of the plurality of predictive models.

16. The non-transitory computer readable medium of claim 13, wherein the plurality of vehicles are mining trucks.

17. The non-transitory computer readable medium of claim 13, wherein each of the predictive models are configured to provide an estimate of activity time for the activity based on a function of corresponding subsets from the one or more subsets of the information and are constructed from machine learning.

18. The non-transitory computer readable medium of claim 13, wherein the activity from the plurality of vehicles is at least one of: hauling and empty operation, loading operation, and dumping operation.
